(19) United States
(12) Patent Application Publication
(10) Pub. No.: US 2024/0378811 A1
(43) Pub. Date: Nov. 14, 2024

(54) STRUCTURE ANCHOR ELEVATION QUERY SERVICE

(71) Applicant: GOOGLE LLC, Mountain View, CA (US)

(72) Inventors: Min Xia, Mountain View, CA (US); John Richard Ullman, Belmont, CA (US); David James Richey, Castro Valley, CA (US); Carlos David Correa Ocampo, Santa Clara, CA (US); Stevan Lacerda Muniz Silva, San Jose, CA (US)

(21) Appl. No.: 18/660,186

(22) Filed: May 9, 2024

Related U.S. Application Data
(60) Provisional application No. 63/501,105, filed on May 9, 2023.
(60) Provisional application No. 63/501,055, filed on May 9, 2023.

(51) Int. Cl. G06T 17/20

(52) U.S. Cl. CPC G06T 17/20

(57) ABSTRACT

A method including receiving a request for an anchor associated with a location, determining whether the location includes a structure, in response to determining the location includes a structure, retrieve data associated with the structure and determine if a quality associated with the data associated with the structure meets a criterion, and in response to determining the quality meets the criterion, return an anchor in response to the request.

### CROSS REFERENCE TO RELATED APPLICATIONS

This application claims the benefit of U.S. Provisional Application No. 63/501,105, filed May 9, 2023, and U.S. Provisional Application No. 63/501,055, filed May 9, 2023, the disclosures of which are incorporated herein by reference in their entireties.

### BACKGROUND

Users of augmented reality (AR), virtual reality (VR), and/or mixed reality (MR) devices often interact with virtual content (e.g., AR/MR/VR content) including virtual objects overlayed on a real-world background. The virtual content can sometimes be located based on geographic anchors.

### SUMMARY

Implementations described herein make it possible for a developer to obtain mesh representations of structures at real-world locations. Therefore, developers of, for example, a map-related or gaming application can use the mesh representations to place virtual content more accurately on the structures. Specifically, the concepts discussed herein are directed to acquiring a mesh geometry that can be used to determine an elevation on structure such as a building based on the mesh geometry. For example, an application may receive a mesh geometry for a location. The application can determine an elevation of a point of interest on the structure represented by the mesh geometry and place virtual content on the structure using the elevation. For example, implementations can relate to generating an elevation for a location that can be based on a terrain elevation and/or a structure elevation and placing an anchor based on the location and the elevation. The elevation can be based on a mesh geometry associated with a structure and a terrain of the location. For example, generating an elevation can be accomplished by performing a lookup of the location within a set of cells, which are indexed to locations on the Earth. When the lookup is done using a service, the set of cells can contain a mesh geometry for structures in the cell. Then the elevation can be determined based on mesh geometry, an anchor can be associated with the elevation, and virtual content can be associated with the anchor such that the virtual content can be accurately located on the structure.

In a general aspect, a device, a system, a non-transitory computer-readable medium (having stored thereon computer executable program code which can be executed on a computer system), and/or a method can perform a process with a method including receiving a request for an anchor associated with a location, determining whether the location includes a structure, in response to determining the location includes a structure, retrieve data associated with the structure and determine if a quality associated with the data associated with the structure meets a criterion, and in response to determining the quality meets the criterion, return an anchor in response to the request.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1 pictorially illustrates the display of virtual content according to at least one example implementation.

FIG. 2 illustrates a table of levels of detail (LODs) of mesh geometries structure according to at least one example implementation.

FIG. 3 is a block diagram of an AR/MR/VR system (or platform) according to at least one example implementation.

FIG. 4A is a diagram illustrating an example S2 cell with mesh geometry buffer included according to at least one example implementation.

FIG. 4B is a diagram illustrating an example S2 cell with a mesh geometry extending outside of the S2 cell according to at least one example implementation.

FIG. 5 is a block diagram illustrating an example signal flow for determining a mesh geometry of an object from an image of the object according to at least one example implementation.

FIG. 6 is a block diagram of a method of generating an anchor according to an example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Users of computing devices (e.g., AR/MR/VR devices) can experience virtual content while moving around in a location. For example, a user of a mobile device executing software can view virtual objects on, for example, landmarks in the real-world environment while observing the display of the mobile device.

Virtual objects can be associated with a location in the real-world environment using geographic anchors, hereinafter referred to as an anchor. At least one technical problem with anchors used to place virtual content in views of the real-world environment is that existing services used to get an anchor for a location in a real-world environment only generate anchors based on a terrain (e.g., ground) elevation. Therefore, existing technology only allows content to be placed in the real-world environment based on terrain elevation, latitude, and longitude. In other words, an anchor is placed at a location based on the location's latitude and longitude. Then, an elevation of zero (0) indicates that the anchor is placed at ground level and a non-zero (e.g., positive) elevation value indicates a distance off the ground for the anchor placement. Therefore, if there is a structure (e.g., building, house, telephone pole, statute, and the like), existing technology does not generate an anchor on (e.g., the top of) the structure or structure elements (e.g., a chimney, a window, an overhang, and the like). Accordingly, existing technology does not enable placement of content on (e.g., on the top of) the structure.

At least one technical solution to the aforementioned technical problem can be to generate an elevation for a location that can be based on a terrain elevation and/or a structure elevation. For example, some implementations can generate an elevation based on a latitude, a longitude, a terrain elevation, and a structure height and/or a height of portions of the structure (e.g., a porch on the side of a building). Therefore, in an AR/VR/MR device content can be placed on (e.g., the top of) the structure using some implementation.

At least one technical effect of the technical solution can be allowing developers of AR/VR/MR to place anchors and virtual objects more accurately within a real-world environment (e.g., real-world environment 105).

For example, if a developer is to place virtual content on the roof top of a building, the developer can obtain a geometric mesh representing the building. The geometric mesh can have a plurality of layers. One of the layers can correspond to the roof top of the building. Therefore, the developer can associate an anchor with the layer corresponding to the roof top of the building. Therefore, the anchor can be placed at an accurate elevation. The developer can associate virtual content with the anchor resulting in accurately placing the virtual content on the rooftop of the building.

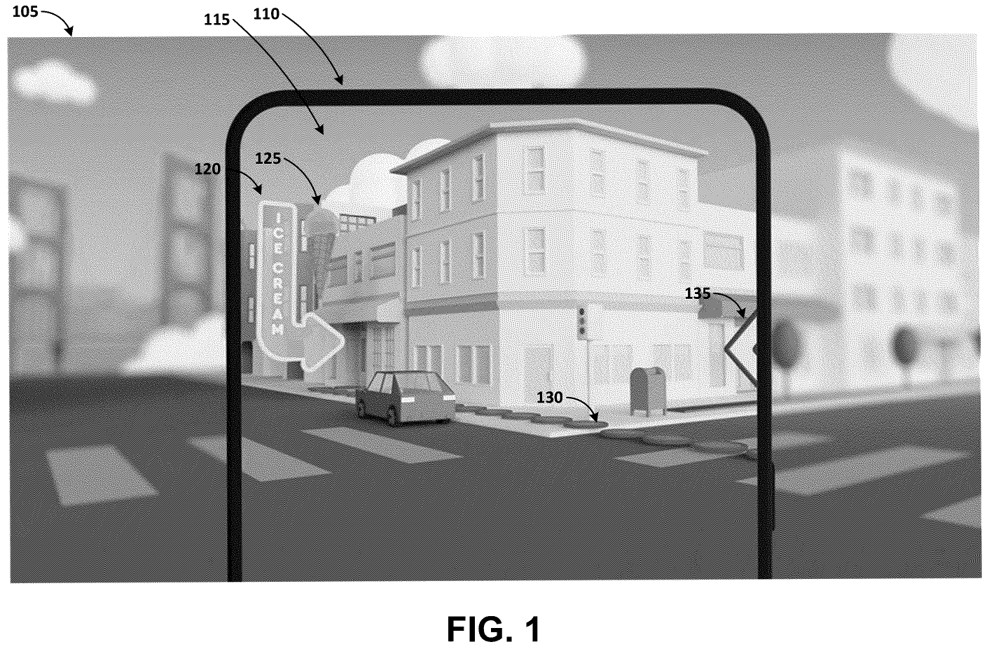

As illustrated in FIG. 1, a user of a mobile device 110 executing software can view virtual objects on, for example, landmarks in a real-world environment 105 while observing the display 115 of the mobile device 110. Virtual objects 120, 125, 130, and 135 can be associated with a location in the real-world environment 105 using anchors. An anchor associated with virtual object 130 would be at ground level and within the capabilities of existing technology. However, an anchor associated with virtual objects 120 and 125 should be relative to the building door (virtual object 120) and just above an overhang of the building (virtual object 125). Therefore, using existing technology to place an anchor for virtual objects 120 and 125 can be problematic. Therefore, some implementations can be used to generate an elevation for a location based on a terrain elevation and a structure elevation. The elevation can be used to place an anchor for virtual objects 120 and 125 more accurately.

In some implementations, an anchor can be a data structure that corresponds to a feature in the real-world. The anchor can be used for placement and/or retrieval of a virtual object associated with the anchor. The data structure can be stored in a memory associated with virtual content. The data structure can include an identification of the anchor, a location of the anchor (e.g., geolocation, a 3D tile identification, and the like), a type of anchor, an associated object and the like.

In some implementations, the anchor(s) can be referred to as persistent anchor(s). In some implementations, persistent anchor(s) can correspond to locations in a real-world location that change infrequently. In some implementations, the anchor(s) and/or persistent anchor(s) can be stored in memory as a data structure, datastore, database and/or the like. In some implementations, the anchor(s) and/or persistent anchor(s) can be stored in a memory associated with geolocation anchor service 340 (described below). In some implementations, the anchor(s) and/or persistent anchor(s) can be associated with virtual content.

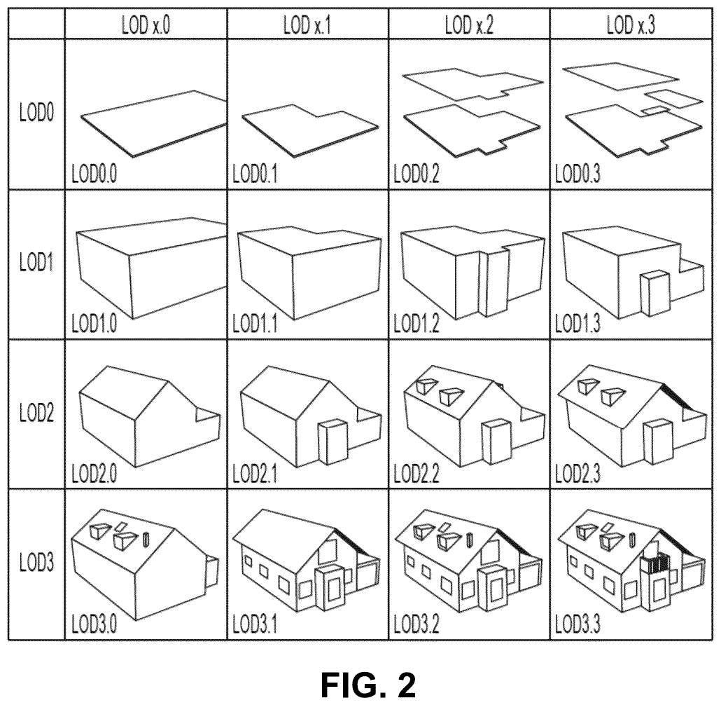

FIG. 2 illustrates a table of levels of detail (LODs) of mesh geometries of a structure according to at least one example implementation. As shown in FIG. 2, the LOD can be described using a first number and a second number. For example, for the first number, LOD0 represents a footprint, LOD1, represents a three-dimensional box over that footprint, and LOD2 and LOD3 represent additional features (e.g., roofs, dormers) that describe the building shape.

In some implementations, for an LODx, there is a second number LODx.y that represents details on the features. For example, LOD2.0 represents a house with a slanted roof, while LOD2.1 has a chimney, and LOD2.2 has dormers on the roof. Moreover, LOD3.1, LOD3.2, and LOD3.3 have semantic features such as windows and doors. Semantic features are features that make a building appear occupied by people.

In some implementations, an application may choose not to access mesh geometries that have a particular LOD. In some implementations, an application (application 320 described below) can choose those LODs that are greater than a threshold, e.g., LODx.y, where x>X and y>Y. For example, X=0 and Y=1. In some implementations, the application can choose those LODs that are smaller than a threshold, e.g., LODx.y, where x<X and y<Y.

In some implementations, quality indicates whether data can be used to accurately place an anchor. For example, the quality that applies to using a mesh geometry to determine an elevation on structure can be that the mesh geometry has sufficient data to accurately place an anchor. For example, a mesh (e.g., in graphics) can be a set of vertices and polygons representing, for example, a 3D object. In other words, mesh is a set of vertices, edges and faces that define the shape of a polyhedral object. Should the mesh geometry representing the structure have too few vertices, edges and/or faces, a determined elevation may be inaccurate, and an anchor placed at the elevation may be placed in an unintended location resulting in developer frustration while placing the anchor.

In some implementations, there is one mesh geometry in a location, and that mesh geometry has an LOD that is not specified by the application. For example, the LOD that is not specified by the application can have an LOD that is below a threshold LOD. Therefore, the LOD that is below the threshold LOD may be below a threshold quality. In other words, to use a mesh geometry for a structure, the mesh geometry should meet some criterion. The criterion can be based on an LOD and/or a minimum LOD. In some implementations, however, there can be more than one mesh geometry in a location for a given object, and those mesh geometries are at different LODs. In that case, the application can select which LOD to access.

In some implementations, the anchor is generated based on the LOD of the mesh geometry representing the structure (e.g., the building). Generating an anchor can include generating a data structure including data representing the anchor. As mentioned above, LODx.y can represent an elevation and feature associated with the mesh geometry. Therefore, an anchor can be placed at a location represented by LODx.y. Accordingly, generating an anchor based on the LOD of the mesh geometry representing the structure can be defined as generating the data structure representing the anchor to include data with the LODx.y as the location on the structure for the anchor.

A developer computing device and/or a client computing device can request information regarding an anchor at a location. For example, the developer computing device can request information to place an anchor. For example, the client computing device can request information about an anchor that exists (or whether an anchor exists). In some implementations, whether or not a structure exists can be determined. For example, a data structure can include an indicator (e.g., a Boolean value, a flag, and/or the like) that can indicate a structure exists or a structure does not exist at the location. For example, if a table of LODs of mesh geometries of a structure is associated with the location, a structure can be determined to exist at the location.

In response to determining the location includes a structure, data associated with the structure can be retrieved. For example, data can be read from memory. For example, a data request can be communicated to a server including the data. For example, the data may have been previously retrieved. In some implementations, a quality associated with the data associated with the structure can be determined. For example, the quality can be based on the LOD of the structure. For example, a minimum LOD may be necessary to place an anchor. For example, an LODx.y equal to LOD0.0 may be insufficient to accurately place an anchor. Whereas an LODx.y equal to LOD1.1 or greater may be sufficient to accurately place an anchor. In some implementations, the LODx.y can be a preconfigured value.

In some implementations, whether the quality associated with the data associated with the structure meets a criterion can be determined. In some implementations, the criterion can be an LODx.y. In some implementations, the criterion (e.g., the LODx.y) can be a preconfigured value. In response to determining that the quality meets the criterion, an anchor can be generated and information (e.g., anchor data) can be communicated in response to the request.

The structure height and/or the height of something (e.g., a chimney) on the structure can be determined using layered mesh data. The layered mesh data can be retrieved from a datastore including layered mesh data associated with structures that can be located at some geographic location. The datastore including layered mesh data can be in one or more datastores and/or a datastore of layered mesh data generated based on layered mesh data from two or more data stores.

FIG. 2 illustrates levels or layers of a structure (in this case a house). In some implementations, the levels or layers of the structure can be indicative of a structure elevation. Referring to FIG. 2, the top row includes images generated using the fewest layers and the bottom row includes images generated using the most layers. The layers are identified as LOD0, LOD1, LOD2, and LOD3 where LOD is level of detail. In addition, layers increase from left to right adding additional detail where the additional layers are identified as LODx.0, LODx.1, LODx.2, and LODx.3. In some implementations a higher LOD number indicates more layers. For example, LOD3 includes more layers than LOD0 and LODx.3 includes more layers than LODx.0.

As mentioned above, the structure height and/or the height of something on the structure can be determined using layered mesh data. For example, the layered mesh data represented by the image (representing a mesh geometry) identified as LOD3.1 can be retrieved from a datastore. For example, the layered mesh could include 10 layers (e.g., layer0 to layer9). In some implementations, the highest (furthest from ground) layer (e.g., layer9) can be the selected layered mesh data and the highest (furthest from ground) point in the layer can be selected. The height of the selected point can be used as the structure height and/or the height of something on the structure.

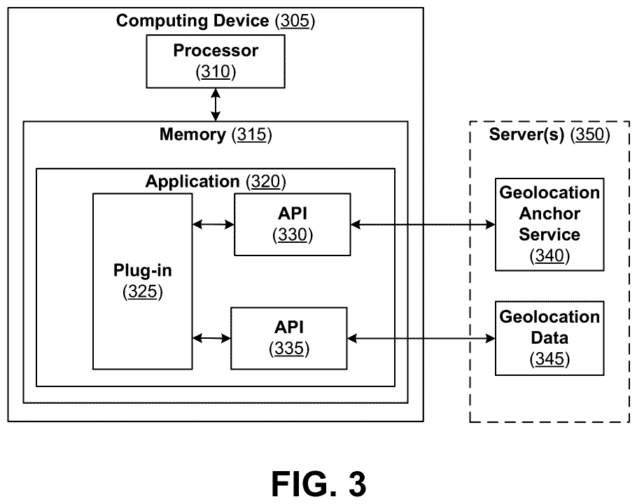

FIG. 3 is a block diagram of a system or platform (e.g., an AR/MR/VR system (or platform)) according to an example implementation. The system (or platform) of FIG. 3 can include, can be an element of, and/or can be developer tools configured to create geospatial experiences remotely. The developer tools can be configured to allow platforms to obtain three-dimensional (3D) tiles for a given location. The 3D tiles can be used by developers and/or content creators to create experiences. The 3D tiles can be sufficient for developers to create anchors.

As shown in FIG. 3, the system includes a computing device 305 and a server(s) 350. The computing device 305 can be a computing device used by a developer to create virtual content. For example, the developer can operate the computing device 305. For example, in some implementations, the system including computing device 305 and a server(s) 350 can be used by developer (e.g., game developer) to develop streaming virtual content (e.g., streaming a game) for the plurality of users to interact with. In some implementations, the developer can use computing device 305 to develop the streaming virtual content while at a remote location to insert virtual objects (e.g., virtual object 120) into a real-world environment (e.g., real-world environment 105) and/or real-world location (e.g., real-world location 205).

As shown in FIG. 3, the computing device 305 includes a processor 310 (e.g., at least one processor) and a memory 315 (e.g., at least one memory, a non-transitory computer-readable storage medium, and the like). Memory 315 includes an application 320 including a plug-in 325, an API 330, and an API 335. Server(s) 350 includes a geolocation anchor service 340 and a geolocation data 345. Computing device 305 and server(s) 350 can be remote from each other and can interact through a wired and/or wireless communication network.

In some implementations, application 320 can be configured to generate virtual reality (VR) content. In some implementations, application 320 can be configured to generate augmented reality (AR) content. In some implementations, application 320 can be configured to generate mixed reality (MR) content. In some implementations, application 320 can be configured to generate virtual content. In some implementations, generating one or more of virtual content can be referred to as generating mixed reality content and/or MR content.

Application 320 can include plug-in 325. Plug-in 325 can be a computer programming tool that can be added to, installed in, installed with, an element of, and/or the like any virtual content creation software. For example, application 320 can be a cross-platform gaming engine or development tool and plug-in 325 can be added to the cross-platform gaming engine or development tool enabling a developer and/or content creator to use the features described in this disclosure. For example, application 320 can be an authoring, developing, and publishing tool and plug-in 325 can be added to the authoring, developing, and publishing tool enabling a developer and/or content creator to use the features described in this disclosure. In some implementations, the application 320 can include a user interface (UI). The UI can include a search tool, an anchor tool, a 3D tile tool, and the like.

Geolocation data 345 can include map data. The map data can be associated with a geo location. The map data can be less detailed (e.g., satellite data), semi-detailed (e.g., road maps, terrain, and the like), detailed (e.g., street level), and/or the like. In some implementations, developer tools can be configured to allow systems or platforms to obtain a plurality of images sometimes referred to as 3D tiles for a given location. In some implementations, 3D tiles can be associated with detailed map data.

In some implementations, 3D tiles can be similar to two-dimensional (2D) tiles (or 2D images) except that 3D tiles contain panoramic imagery taken at street level. 3D tiles can be used to explore world landmarks, see natural wonders, and step inside places such as museums, arenas, restaurants, or small businesses. Geolocation data 345 via API 335 can be configured to enable access to detailed or street level 3D tiles, street level metadata, street level thumbnail images, and the like. Developers can use geolocation data 345 via API 335 stitch together image tiles taken from the street level to create a real-life panoramic view of real-world locations. In some implementations, searching and querying a location can return a plurality (e.g., 10, 50, 100, 200, and the like) images representing a real-world location. In some implementations, each image can have a unique identification. In some implementations, the plurality of images representing a real-world location can have a unique identification. In some implementations, the plurality of images representing a real-world location can have metadata about each image and/or each location (e.g., group of images). The metadata can include tile height, tile width, latitude, longitude, tilt, roll, image type, address, and/or the like.

In some implementations, the 3D tiles can be, can correspond to, and/or can include an S2 cell. Alternatively, or in addition, an S2 cell can be, can correspond to, and/or can include 3D tile(s). Accordingly, in some implementations, geolocation data 345 can include data (e.g., mesh data) associated with an S2 cell. In some implementations, end user devices and/or client devices (e.g., AR/MR/VR user devices) can include an application(s) configured to access S2 cell data using, for example, an API. In some implementations, a content developer or creator computer devices can include an application(s) (e.g., application 320) configured to access S2 cell data using, for example, an API.

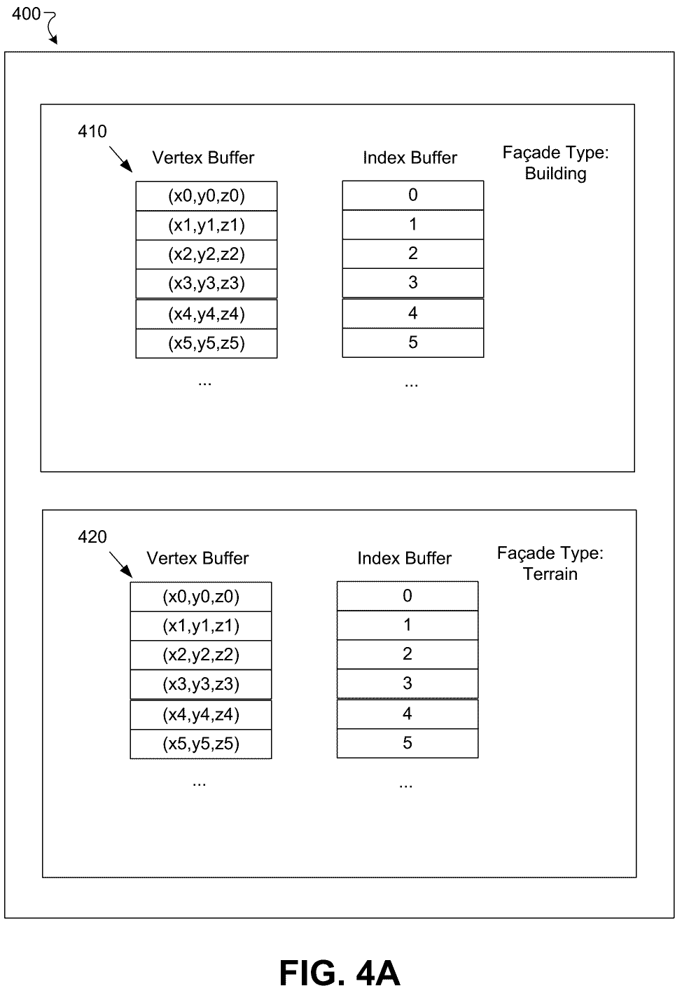

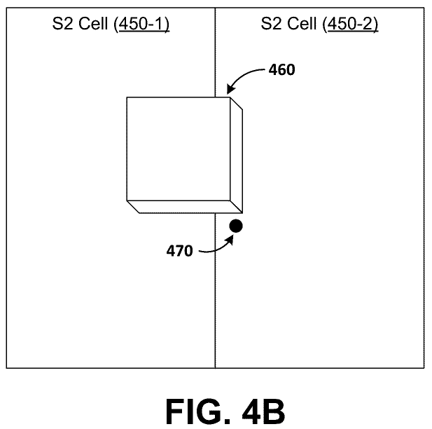

FIG. 4A is a diagram illustrating an example S2 cell 400 with mesh geometry buffer included. Structure (e.g., building) and terrain (streetscape) geometry can be grouped by S2 cells. S2 cells can be hierarchically arranged divisions of the Earth into sections of a sphere that approximates the Earth's shape. An S2 cell can be quadrilateral bounded by four geodesics. Cell levels range from 0 to 30. The smallest cells at the lowest level of hierarchy are called leaf cells and there are 6*4\hat{ }30 leaf cells, a leaf cell can be about 1 cm across on the surface of the Earth. An S2 cell can contain a terrain and/or a structure; this can be represented as a mesh geometry. A terrain can be equivalent to the ground or ground level if there is no structure (e.g., manmade structure) at the location. Terrain and structure mesh geometries in one S2 cell can be grouped in one mesh geometry. A mesh geometry in the streetscape geometry includes a type (e.g., building, terrain) for a face in the meshes. This is an inefficient representation because developers might loop through a buffer to get a terrain mesh if they want only the terrain mesh. Thus, some implementations can partition the streetscape geometry structures in one S2 cell by terrain 420 and structures 410, as shown in FIG. 4A.

A developer computing device and/or a client computing device can request information regarding an anchor at a location. For example, the developer computing device can request information to place an anchor. For example, the client computing device can request information about an anchor that exists (or whether an anchor exists). In some implementations, whether or not a structure exists can be determined. For example, a data structure can include an indicator (e.g., a Boolean value, a flag, and/or the like) that can indicate a structure exists or a structure does not exist at the location. For example, if a table of LODs of mesh geometries of a structure is associated with the location, a structure can be determined to exist at the location. For example, a table of LODs of mesh geometries can be requested from a server (e.g., server(s) 350). In response to the request, the server can communicate S2 cell 400 data including a terrain 420 data and/or structures 410 data. If only terrain 420 data is communicated, no structure exists for the location. If both terrain 420 data and structures 410 data is communicated, a structure exists for the location.

Moreover, when computing rooftop elevation for a particular location, a goal is to have an ability to efficiently and reliably access the mesh geometry which might be considered part of the rooftop surface at that location. This rooftop surface, for example, the top of a structure at a given horizontal location or terrain if there is no structure at the given location, includes both the global streetscape geometry terrain and structure mesh geometry which covers the location. Nevertheless, reliably or efficiently finding the global streetscape structure geometry which might cover a given location can be difficult. For example, global streetscape structure geometry can be approximately spatially indexed.

A tile is aligned at a 1:1 scale with S2 cells. In some implementations, tiles can be partitioned by level 15 S2 cells (e.g., between 281 m and 306 m wide). A tile can include the terrain mesh geometry which covers that S2 cell and a mesh geometry for any structure whose centroid is within that S2 cell's boundaries. In some implementations, the mesh geometry of a structure within one tile can extend outside of the boundaries of the tile's associated S2 cell, into regions that may be represented by other tiles.

FIG. 4B is a diagram illustrating an example S2 cell 450-1 with a structure 460 extending outside of the S2 cell 4501. For example, in FIG. 4B, while most of the structure 460 is in S2 cell 450-1, the centroid 470 is in a neighbor S2 cell 450-2. Thus, to find the structure mesh geometry which covers a particular region can include examining two or more tiles. In other words, some mesh geometry covering a location can be included in other nearby tiles (e.g., a tile associated with S2 cell 450-2). For example, at least one tile adjacent to the tile corresponding to the S2 cell 450-1 (e.g., the tile that includes the location) should be identified and examined for the structure. Determining which tiles to inspect to identify the mesh geometry that can cover a given location can be difficult.

Some implementations can include partitioning the mesh geometry in one S2 cell into one terrain and multiple structures geometry, as shown in FIG. 4A. Such implementations can also involve splitting structure mesh geometry along tile boundaries and, within a tile, storing the mesh geometries which fall within the tile's associated S2 cell, including partial meshes for structures which straddle multiple cells, and none of the structure geometry which falls outside of the S2 cell.

As stated previously, applications can obtain the vertices and indices buffers in structures and terrain (streetscape) mesh geometry, which can perform a copy of a mesh geometry buffer in an access. Copying a mesh geometry buffer at every access is inefficient because copying uses a loop over the buffer and is an O(N) operation in time, where N is the number of vertices in the mesh geometry buffer.

Some implementations can include a mesh geometry application programming interface (API) providing pointers to buffers in which the mesh geometry representation of a structure, e.g., where vertex and index buffers of the streetscape geometry mesh, are stored. This can avoid copying at an access point. Since little prevents applications from editing any other memory block, e.g., applications can typecast a geometry pointer to a character pointer. In this case, by casting the geometry pointer to a character pointer, an application can cause a computer to reinterpret the bits in the geometry session as characters. Because both geometry pointers and character pointers would point to the same location in memory, the content stored in that location may be overridden. Accordingly, this recasting of the geometry pointers can be a good choice if it is assumed the application is not malicious.

Moreover, the geometry session pointer can be a shared pointer, which means the pointer can be valid as long as the developer still refers to it. That is, a shared pointer can be used when one heap-allocates a resource that is shared among multiple objects. The shared pointer can maintain a reference count internally and can delete the resource when the reference count goes to zero. In this way, a developer API can access mesh geometry data even though a mesh geometry session terminated the mesh geometry data. In some implementations, mesh geometries can be retrieved from about a 100 m radius of a current position and the buffers in mesh geometries can update (e.g., one time) when parsing a response from the server. The mesh geometry can be static. The pose in mesh geometry can be updated with location changes. Accordingly, if pointers to buffers are provided, there is no concern about overwriting the memory that the application is trying to read.

In some implementations, structure and terrain (streetscape) geometry can be downloaded at the beginning of a session. Based on observed data, the 95th percentile of network data size per session is about 11 MB and the 95th percentile of mesh geometry response data size can be about 3.5 MB. This means mesh geometry can increase about 32% data per augmented reality (AR) session. Moreover, for a one-minute session, a visual positioning system (VPS) can use about 1-3 MB while mesh geometries in one location can use about 0.5 MB, e.g., a 20-50% increase in data usage if mesh geometries are enabled. This can inefficiently utilize network and local storage if an application (e.g., application 320) does not use a Streetscape Geometry API.

Some implementations can be directed to adding a mode(s) (e.g., StreetscapeGeometryMode) as an AR session configuration. An AR session can manage the AR system state and handles the session lifecycle. This class can be the main entry point into the Streetscape Geometry API. This class can enable the application to create a session, configure the session, start or stop the session, and receive frames that allow access to a camera image and device pose. If an application accesses a streetscape geometry, the application may configure the AR session with the mode(s) (e.g., StreetscapeGeometryMode). Applications may then be configured to activate a toggle that stops (e.g., causes the stopping of) receiving images (frames). An application can begin receiving images at any time if the application uses the Streetscape Geometry API.

Returning to FIG. 3, server 350 can include, at least, geolocation anchor service 340 and geolocation data 345 (described above). In some implementations, geolocation anchor service 340 can be configured to store (e.g., in a memory, a data structure, a database, and/or the like) a set of visual feature points sometimes referred to as an anchor. In some implementations, an anchor can be a data structure that corresponds to the feature in the real-world. The data structure can be stored in a memory associated with virtual content. The data structure can include an identification of the anchor, a location of the anchor (e.g., geolocation, a 3D tile identification, and the like), a type of anchor, an associated object and the like.

For example, the anchor can be used to localize an AR environment for a secondary user (e.g., user's 125) of an AR/MR/VR session (e.g., a streaming game). In some implementations, an anchor can be used to compare and match against other anchors identified by a secondary user's computing device to determine whether the real-world environment is the same as the physical space of stored anchors and to calculate the location of the secondary user's computing device within the real-world environment.

In some implementations, virtual content can be associated with an anchor. The virtual content can include an object or virtual object (e.g., 3D objects), annotations, balloons, and/or other information. For example, a developer or content creator can associate a game character with the corner of a street or annotate a street sign with information about businesses on the street. Motion tracking means that you can move around and view these objects from any angle, and even if a user turns around and/or leaves the location (e.g., street), when the user returns, the game character or annotation will be there in the same location.

In some implementations, geolocation anchor service 340 can be configured to generate an anchor that corresponds to a latitude, longitude, and altitude of a geolocation. In some implementations, geolocation anchor service 340 can be configured to generate an anchor that corresponds to a terrain at the geolocation. In some implementations, geolocation anchor service 340 can be configured to generate an anchor that corresponds to an elevation (or façade, rooftop, and the like) at the geolocation. In some implementations, geolocation anchor service 340 can be configured to generate an anchor that corresponds to a location, façade, rooftop, altitude, and the like within a 3D tile of a geolocation. In some implementations, geolocation anchor service 340 can be configured to determine whether a structure exists at a location. In some implementations, geolocation anchor service 340 can be configured to determine whether a 3D tile includes a structure(s). In some implementations, geolocation anchor service 340 can be configured to determine whether s2cell includes a structure(s).

In some implementations, services associated with geolocation anchor service 340 can be linked to the plug-in 325 via API 330. In some implementations, services associated with geolocation data 345 can be linked to the plug-in 325 via API 335. An application programming interface or API can be configured to provide a mechanism for two or more computer programs or components to communicate. Geolocation anchor service 340 can include computer programs or components sometimes referred to as libraries, classes, and/or class methods for creating, deleting, updating, modifying, and the like anchors. For example, geolocation anchor service 340 can include a class method for creating an anchor and a class method for associating an object, an annotation, and the like with the anchor. In some implementations, an anchor can include a data structure including an identification of the anchor, a location of the anchor (e.g., geolocation, a 3D tile identification, and the like), a type of anchor, an associated object and the like. Therefore, the class method for creating an anchor can be configured to generate an anchor data structure, assign a unique identification to the anchor and associate a location with the anchor. Further, the class method for updating and/or modifying the anchor can be configured to associate virtual content with the anchor. Therefore, in some implementations, API 330 can be configured to provide access to the class method for creating an anchor, the class method for updating and/or modifying the anchor, and the like.

In some implementations, geolocation data 345 can include a plurality of images representing a real-world location (or 3D tiles) and computer programs or components sometimes referred to as libraries, classes, and/or class methods for accessing the plurality of images. For example, the class method for accessing the plurality of images can include a location search tool, an image(s) retrieve tool, and the like. Therefore, the class method for location search can include a location input function and a location return function. The location input function can be configured to take a location name, a point of interest, an address, a latitude and longitude, and the like as input. The location return function can be configured to return information about a location (e.g., an image, a location identification, a location legend (e.g., legend 210), and the like. The class method for image(s) retrieve can return a plurality of images representing a real-world location based on, for example, a location identification, a number of images, a range (e.g., in meters or feet from a center), and/or the like.

In some implementations, an elevation service (e.g., GeoAR TerrainService.BatchQueryElevations) can be called by an AR/VR/MR device and/or a device configured to generate content for the AR/VR/MR device. The elevation service can be software code executed by a remote device. A remote device can be, for example, a computer server. The software code can be called with a location (e.g., latitude and longitude) and return an elevation for the location. The software code can be configured to determine (e.g., look-up, read from a database, and/or the like) a terrain elevation based on the location.

In some implementations, a terrain elevation is the vertical distance of a geographic location above a reference height (e.g., sea level). For example, a terrain elevation can be included with map data associated with the surface of the Earth. Map data can include surface information about locations (e.g., latitude and longitude) on the Earth. Sometimes this map data is associated with the contour and/or topology of the Earth. In some implementations, terrain elevation is based on a reference level being sea level. Accordingly, terrain elevation data can include latitude, longitude, and a sea level referenced elevation.

The software code can be further configured to determine if there is a structure at the location, and if there is a structure at the location determine (e.g., look-up, read from a database, and/or the like) a structure elevation based on the location. In some implementations, the software code can be further configured to return either the terrain elevation, the structure elevation (if there is a structure at the location), or the terrain elevation plus the structure elevation (if there is a structure at the location) as the elevation for the location. For example, if there is no structure the terrain elevation can be returned. For example, if there is a structure and the structure elevation does not include the terrain elevation, the structure elevation plus the terrain elevation can be returned. For example, if there is a structure and the structure elevation includes the terrain elevation, the structure elevation can be returned. As mentioned above, the structure elevation can be the structure height and/or the height of something on the structure represented by layered mesh data.

In some implementations, a location repeated field (e.g., indicator, flag, and/or the like) can be used to specify a plurality of locations to generate an elevation. For example, a batch of locations for which to query terrain elevation can be used to extend the elevation service. In some implementations, the elevation service can be extended to include whether to return terrain elevation or to consider both terrain and structure geometry when generating the elevation to return. For example, a query for an elevation(s) (e.g., ElevationQuery proto) message type can be defined which includes a location and a flag indicating whether the query should consider (e.g., when calling the service) structure geometry (e.g., layered mesh data). An example query message (e.g., software code) can be in listing 1.

Listing 1

// Represents the query for the elevation at a single location on Earth's
// surface.
message ElevationQuery {
// The Earth surface location for which to query elevation.
optional LatLng location = 1;
// Whether structure geometry should be considered when determining
surface
// elevation. If ‘false’, only terrain geometry will be considered and the
// resulting elevation will be that of the terrain at the specified location.
// If ‘true’, both terrain and structure geometry will be considered. The
// resulting elevation will be the greatest of any terrain or structure
// geometry covering the specified location.
optional bool include_ structure = 2;
}

In some implementations, a location repeated field (e.g., indicator, flag, and/or the like) can be used to specify a plurality of locations to generate an elevation. For example, a batch of locations for which to query terrain elevation can be used to extend the elevation service. In some implementations, the elevation service can be extended to include whether to return terrain elevation or to consider both terrain and structure geometry when generating the elevation to return. For example, a query for an elevation(s) (e.g., ElevationQuery proto) message type can be defined which includes a location and a flag indicating whether the query should consider (e.g., when calling the service) structure geometry.

In some implementations, a structure geometry quality can be determined. For example, the structure geometry data can be tagged (e.g., have a predetermined quality value). For example, the structure geometry data can be read, and a structure geometry quality can be generated based on the structure geometry data. In some implementations, the layered mesh data (e.g., as described with regard to FIG. 1) can include information corresponding to the structure geometry quality of the layered mesh data. For example, the LOD can represent the structure geometry quality. In some implementations a low LOD (e.g., LOD 1.0) may not meet the criterion. In some implementations a high LOD (e.g., LOD 3.1) may meet the criterion.

If the structure geometry quality meets some criterion, a structure elevation for the location can be used in an elevation calculation. For example, if the structure geometry quality is above (or, alternatively, below) a threshold value, a structure elevation for the location can be used in an elevation calculation. Otherwise, the terrain elevation alone can be used as the elevation for the location. In other words, the terrain elevation can be a fallback or alternative elevation for the location should the structure elevation be inaccurate (e.g., the structure geometry quality does not meet some criterion). An example query message (e.g., software code) can be in listing 2.

Listing 2

```
// Represents the query for the elevation at a single location on Earth's
// surface.
message ElevationQuery {
// The Earth surface location for which to query elevation.
optional LatLng location = 1;
// Whether structure geometry should be considered when determining
surface
// elevation. If ‘false’, only terrain geometry will be considered and the
// resulting elevation will be that of the terrain at the specified location.
// If ‘true’, both terrain and structure geometry will be considered. The
// resulting elevation will be the greatest of any terrain or structure
// geometry covering the specified location.
optional bool include_structures = 2
  // determine if quality meets a criterion
  { structuredataquality
  // if quality does not meet the criterion
  // do not include structure
  { structures = 0}
};
}
```

An example batch query message (e.g., software code) can be in listing 3.

Listing 3

message BatchQueryElevationsRequest {
...
// Deprecated. Use ‘queries' instead.
repeated LatLng locations = 1 [deprecated = true];
// The elevation queries in this batch.
repeated ElevationQuery queries = 4;
...
}

When computing elevation for a particular location, the geometry which may be considered part of the surface at the location should be efficiently and reliably accessed. This can include the global streetscape geometries terrain and the structure geometry which covers the location. However, reliably, and efficiently determining all of the global streetscape geometry's structure geometry that may cover a given location can be difficult.

For example, streetscape geometry's structure geometry can be approximately spatially indexed. Global streetscape geometry tiles can be partitioned by geographic tiles or cells (e.g., level 15 S2 cells). Each tile can contain the terrain geometry which covers that cell and a 3D mesh for any structures whose centroid is within that cell's boundaries. However, the geometry of a structure contained within one global streetscape geometry's tile may extend outside of the boundaries of the tile's associated cell, into regions supposedly represented by other tiles. Therefore, in order to determine all of the structure geometry which covers a particular region, considering the global streetscape geometry's tile corresponding to the cell that contains that location can be insufficient. Some structure geometry covering that location may be included in other nearby tiles.

As an example method, a request for an anchor associated with a location is received. Whether or not the location includes a structure is determined. In response to determining the location includes a structure, retrieve data associated with the structure and return an anchor determined based on the data associated with the structure in response to the request. The device making the request for the anchor can generate an AR view including content located at the anchor.

In some implementations, when computing elevation for a particular location, a predetermined radius can be used to specify a circular area around the location. Further, global streetscape geometry's tiles which intersect that area for structure geometry covering the location can be identified and inspected.

In some implementations, when computing elevation for a particular location, structure meshes can be divided along streetscape geometry tile boundaries. Further, within each streetscape geometry's tile, the structure geometry that falls within the tile's associated cell can be stored. This can include storing partial meshes for structures that straddle multiple cells, and none of the structure geometry which falls outside of the cell.

In some implementations, structure meshes can remain as complete meshes for the structure. Further, the complete meshes can be stored separately from an associated streetscape geometry's tile. Each stored streetscape geometry's tile can include a reference to the structure meshes that are included in and intersect with the cell.

As an example method, a request for an anchor associated with a location is received. Whether or not the location includes a structure is determined. In response to determining the location includes a structure, retrieve data associated with the structure and determine if a quality associated with the data associated with the structure meets a criterion. If the quality meets the criterion, return an anchor determined based on the data associated with the structure in response to the request. Otherwise, return an anchor determined based on a terrain elevation of the location in response to the request. The device making the request for the anchor can generate an AR view including content located at the anchor.

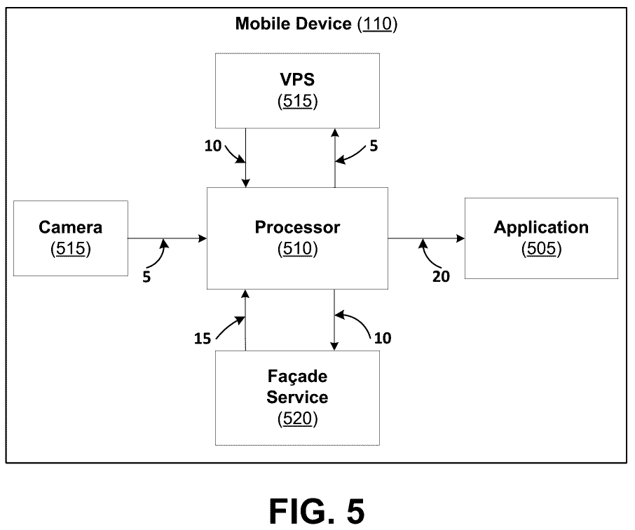

FIG. 5 is a block diagram illustrating an example signal flow for determining a mesh geometry of an object from an image of the object according to at least one example implementation. The signal flow can be implemented in a computing device used for developing and/or creating AR/VR/MR content. The signal flow can be implemented in a computing device used for interacting with AR/VR/MR content. For example, the signal flow can be implemented in an AR/VR/MR user device or client. For example, the signal flow can be implemented in head mounted display (HMD), smart glasses, a mobile device, a laptop computer, a tablet computer and the like configured to develop and/or interact with AR/VR/MR content. The signal flow is not limiting and there may be other flow topologies that may accomplish a similar result.

As shown in FIG. 5, a camera 525 associated with an application 505 can capture and communicate an image 55 to processor 510. In some implementations, the camera 525 can be a camera of a mobile device on which the application 505 is being developed. In some implementations, the camera 525 can be a camera of an augmented reality/extended reality device on which the application 505 is operating.

In some implementations, an application development support system can operate on processor 510. The application development support system can be configured to provide data and code that, when executed, causes the application 505 to perform map-related operations. For example, the application development support system can include a software development kit (SDK) that provides code for augmented reality-related applications.

The image 55 can include an image of a real-world environment including, for example, a structure, a building, an object, and/or the like. In some implementations, image 55 can include images of other objects such as landmarks (e.g., signs) that may be used to identify the object.

In response to receiving the image 55, the processor 510 can be configured to determine a location 10 of the object in the image 55. In some implementations, the processor 510 can be configured to determine the location 10 by sending the image to a visual positioning system (VPS) 515. A VPS (e.g., VPS 515) can be a positioning system configured to use computer vision and machine learning algorithms to determine the location of a device in the physical world. In some implementations, location 10 can be a three-dimensional location. In some implementations, when the object is a building, the three-dimensional location can correspond to a rooftop of the building.

The processor 510 then uses the location 10 to determine a mesh geometry for the object. In some implementations, the processor 510 can perform a lookup operation of an S2 cell 15 in a façade service 520. An S2 cell (as described above) can be a section of the Earth, bounded by four geodesics, and indexed along a space-filling curve superimposed on the Earth. That is, an S2 cell 15 can correspond to a location on Earth and can be searched for in a directory by location. Moreover, the façade service 520 can be configured to provide a mesh geometry 20 for an object at location 10 in an S2 cell 15. In this way, an S2 cell can be a data structure representing a section of the Earth including the location of the object, the data structure including the mesh geometry representation of the object.

In some implementations, the mesh geometry 20 can be provided at a level of detail (LOD). As described above, an LOD can represent a measure of fidelity a mesh geometry has to the object it represents. In some implementations, an LOD can be indicative of a number of vertices of a mesh geometry. In some implementations, an LOD can be indicative of a number of edges of a mesh geometry. In some implementations, an LOD can be indicative of a number of faces of a mesh geometry. In some implementations, the LOD can be provided by the façade service 520 for a particular object. In some implementations, there can be more than one LOD for a given object.

The processor 510 then provides the mesh geometry 20 to the application 505. For example, application 505 can access mesh geometry 20 by copying the buffer in the S2 cell where the vertex information defining the mesh geometry is stored. For meshes of high LODs, however, this can be a costly operation in terms of resources. A solution to this problem is described above.

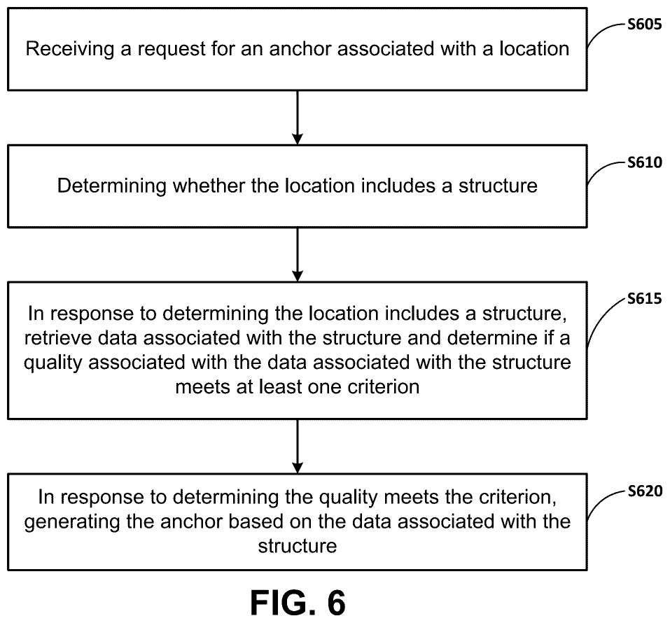

Example 1 FIG. 6 is a block diagram of a method of generating an anchor according to an example implementation. As shown in FIG. 6, in step S605 receiving a request for an anchor associated with a location. In step S610 determining whether the location includes a structure. In step S615 in response to determining the location includes a structure, retrieve data associated with the structure and determine if a quality associated with the data associated with the structure meets a criterion. In step S620 in response to determining the quality meets the criterion, generating the anchor based on the data associated with the structure. In some implementations, the method can further include communicating the anchor in response to the request.

Example 2. The method of Example 1, wherein the data associated with the structure can include a level of detail (LOD) of mesh geometries of the structure and the anchor is generated based on the LOD of mesh geometries.

Example 3. The method of Example 1 can further include in response to determining the location does not include a structure, generating the anchor based on a terrain elevation of the location and communicating the anchor in response to the request.

Example 4. The method of Example 1 can further include in response to determining the quality does not meet the criterion, generating the anchor based on a terrain elevation of the location and communicating the anchor in response to the request.

Example 5. The method of Example 1, wherein the determining of whether the location includes a structure can include reading data from a data structure, the data indicating whether or not the location includes the structure.

Example 6. The method of Example 1, wherein the determining of whether the location includes a structure can include determining a mesh geometry representation of the location, the mesh geometry indicating whether or not the location includes the structure.

Example 7. The method of Example 6, wherein determining the mesh geometry representation of the location can include sending the location to a façade service and receiving, from the façade service, a data structure representing a section of the Earth including the location, the data structure including a mesh geometry representation of the structure. In some implementations, the mesh geometry representation of the location includes at least one of a mesh geometry of the structure and a mesh geometry representation of a terrain associated with the location.

Example 8. The method of Example 7, wherein the mesh geometry representation of the structure can have a level of detail (LOD) indicative of a number of edges of the structure.

Example 9. The method of Example 8, wherein the data associated with the structure includes a level of detail (LOD) of mesh geometries of the structure and the criterion is based on the LOD.

Example 10. The method of Example 6, wherein the mesh geometry representation of the structure can be separate from the mesh geometry representation of a terrain associated with the location.

Example 11: A method can include receiving a request for an anchor associated with a location, determining whether the location includes a structure, in response to determining the location does not include a structure: generating the anchor based on a terrain elevation of the location and communicating the anchor in response to the request, in response to determining the location includes a structure: retrieving data associated with the structure and determining if a quality associated with the data associated with the structure meets a criterion, in response to determining the quality does not meet the criterion: generating the anchor based on a terrain elevation of the location and communicating the anchor in response to the request, and in response to determining the quality meets the criterion: generating the anchor based on the data associated with the structure and communicating the anchor in response to the request.

Example 12. A method can include any combination of one or more of Example 1 to Example 11.

Example 13. A non-transitory computer-readable storage medium comprising instructions stored thereon that, when executed by at least one processor, are configured to cause a computing system to perform the method of any of Examples 1-12.

Example 14. An apparatus comprising means for performing the method of any of Examples 1-12.

Example 15. An apparatus comprising at least one processor and at least one memory including computer program code, the at least one memory and the computer program code configured to, with the at least one processor, cause the apparatus at least to perform the method of any of Examples 1-12.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A method comprising:
receiving a request for an anchor associated with a location;
determining whether the location includes a structure;
in response to determining the location includes a structure,
retrieving data associated with the structure, and
determining if a quality associated with the data associated with the structure meets at least one criterion; and
in response to determining the quality meets the at least one criterion, generating the anchor based on the data associated with the structure.

2. The method of claim 1, wherein
the data associated with the structure includes a level of detail (LOD) of mesh geometries of the structure, and
the anchor is generated based on the LOD of mesh geometries.

3. The method of claim 1, further comprising:
in response to determining the location does not include a structure,
generating the anchor based on a terrain elevation of the location, and
communicating the anchor in response to the request.

4. The method of claim 1, further comprising:
in response to determining the quality does not meet the at least one criterion,
generating the anchor based on a terrain elevation of the location, and
communicating the anchor in response to the request.

5. The method of claim 1, wherein the determining of whether the location includes a structure includes:
reading data from a data structure, the data indicating whether or not the location includes the structure.

6. The method of claim 1, wherein the determining of whether the location includes a structure includes:
determining a mesh geometry representation of the location, the mesh geometry indicating whether or not the location includes the structure.

7. The method of claim 6, wherein the mesh geometry representation of the location includes at least one of a mesh geometry representation of the structure and a mesh geometry representation of a terrain associated with the location.

8. The method of claim 1, wherein
the data associated with the structure includes a level of detail (LOD) of mesh geometries of the structure, and
the at least one criterion is based on the LOD.

9. A system comprising at least one processor and at least one memory including computer program code, the at least one memory and the computer program code configured to, with the at least one processor, cause the system to:
receive a request for an anchor associated with a location;
determine whether the location includes a structure;
in response to determining the location includes a structure,
retrieve data associated with the structure, and
determine if a quality associated with the data associated with the structure meets a criterion; and
in response to determining the quality meets the criterion, return an anchor in response to the request.

10. The system of claim 9, wherein the anchor is determined based on the data associated with the structure.

11. The system of claim 9, wherein the program code is further configured to cause the system to:
in response to determining the location does not include a structure, return an anchor determined based on a terrain elevation of the location.

12. The system of claim 9, wherein the program code is further configured to cause the system to:
in response to determining the quality does not meet the criterion, return an anchor determined based on a terrain elevation of the location.

13. The system of claim 9, wherein the determining of whether the location includes a structure includes:
reading data from a data structure, the data indicating whether or not the location includes the structure.

14. The system of claim 9, wherein the determining of whether the location includes a structure includes:
determining a mesh geometry representation of the location, the mesh geometry indicating whether or not the location includes the structure.

15. The system of claim 14, wherein the mesh geometry representation of the location includes at least one of a mesh geometry representation of the structure and a mesh geometry representation of a terrain associated with the location.

16. The system of claim 9, wherein
the data associated with the structure includes a level of detail (LOD) of mesh geometries of the structure, and
the criterion is based on the LOD.

17. A non-transitory computer-readable storage medium comprising instructions stored thereon that, when executed by at least one processor, are configured to cause a computing system to:
receive a request for an anchor associated with a location;
determine whether the location includes a structure;
in response to determining the location does not include a structure,
generate the anchor based on a terrain elevation of the location, and
communicate the anchor in response to the request;
in response to determining the location includes a structure,
retrieve data associated with the structure, and
determine if a quality associated with the data associated with the structure meets a criterion;
in response to determining the quality does not meet the criterion,
generate the anchor based on a terrain elevation of the location, and
communicate the anchor in response to the request; and
in response to determining the quality meets the criterion,
generate the anchor based on the data associated with the structure, and
communicate the anchor in response to the request.

18. The non-transitory computer-readable storage medium of claim 17, wherein
the data associated with the structure includes a level of detail (LOD) of mesh geometries of the structure, and
the anchor is generated based on the LOD of mesh geometries.

19. The non-transitory computer-readable storage medium of claim 17, wherein the determining of whether the location includes a structure includes:
determining a mesh geometry representation of the location, the mesh geometry indicating whether or not the location includes the structure.

20. The non-transitory computer-readable storage medium of claim 19, wherein the mesh geometry representation of the location includes at least one of a mesh geometry representation of the structure and a mesh geometry representation of a terrain associated with the location.
